(19) United States
(12) Patent Application Publication
(10) Pub. No.: US 2021/0324540 A1
(43) Pub. Date: Oct. 21, 2021

(54) METHODS AND SYSTEMS FOR FABRICATING NANOFIBER MATERIALS

(71) Applicant: FERMI RESEARCH ALLIANCE, LLC, BATAVIA, IL (US)

(72) Inventor: Sujit Bidhar, Carol Stream, IL (US)

(21) Appl. No.: 17/236,983

(22) Filed: Apr. 21, 2021

Related U.S. Application Data
(60) Provisional application No. 63/013,362, filed on Apr. 21, 2020.

(51) Int. Cl. D01D 5/00

(52) U.S. Cl. CPC D01D 5/003; A41D 13/11; D10B 2321/042

(57) ABSTRACT

Systems and methods for creating coating a substrate with nanofiber comprise a dual polarity high voltage power supply, a first wire for wire electrospinning held at positive potential by the power supply, a second wire held at negative potential by the power supply and a spooling system for drawing a substrate between the first wire and the second wire. A slider and a solution chamber in fluidic connection with the slider are used to slide along the first wire delivering solution to the wire.

### CROSS REFERENCE TO RELATED PATENT APPLICATION

This patent application claims the priority and benefit, under 35 U.S.C. § 119(e), of U.S. Provisional Patent Application Ser. No. 63/013,362, filed Apr. 21, 2020, and titled “METHODS AND SYSTEMS FOR FABRICATING NANOFIBER MATERIALS”. U.S. Provisional Application Ser. No. 63/013,362 is incorporated herein by reference in its entirety.

### STATEMENT OF GOVERNMENT RIGHTS

The invention described in this patent application was made with Government support under the Fermi Research Alliance, LLC, Contract Number DE-AC02-07CH11359 awarded by the U.S. Department of Energy. The Government has certain rights in the invention.

### TECHNICAL FIELD

Embodiments are generally related to electrospinning. Embodiments are further related to methods and systems for manufacturing nanofiber. Embodiments are further related to methods and systems for coating substrates to create protective materials. Embodiments are additionally related to methods and systems for producing a variety of ceramic nanofibers using very low power output and low voltage DC input using DC to DC voltage converters with dual polarity and a high voltage DC supply. Embodiments are further related to methods and systems for fabricating multi-layered masks.

### BACKGROUND

Electrospinning is a method used to produce polymeric nanofiber. Electrospinning methods typically require application of high voltage to a drop of liquid, causing the liquid to become charged. The charged liquid droplet is then stretched toward a collector. The elongated droplet dries as it travels to the collector. The drying fiber is subject to a whipping process that increases the path of travel, resulting in the formation of very thin fibers.

Conventional electrospinning requires sophisticated and expensive power supply units which are bulky, operate at high input voltage, and have high power output (e.g. running into the hundreds of watts). Such systems pose electrical hazards. In cases where it is desirable to have both positive and negative high voltage output, two such power supplies are required, effectively doubling the problems associated with the system complexity, bulkiness, and safety.

Conventional N95 masks used by health practitioners, have only 95% filtering efficiency for particles of 2.5 microns, and less than 60% filtering efficiency for 1 micron sized particle. As such, these masks don't offer sufficient protection against transmission of bacteria and viruses. Conventional face masks are made from a non-woven polypropylene material using a melt blown process, resulting in average fiber diameter of 5-10 microns, with an average pore opening size of about 10 microns. For filtering smaller particles, the conventional approach is the use of multiple layers of these filter cloths resulting in a thick face mask that makes it difficult to breathe. Typical pressure drop across an N95 mask is around 345 Pa at 85 L/min flow rate.

Accordingly, there is a need in the art for improved methods, systems, and apparatuses for mass producing filtering cloth as disclosed herein.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide a method and system for electrospinning.

It is another aspect of the disclosed embodiments to provide a method and system for producing a variety of nanofibers.

It is another aspect of the disclosed embodiments to provide methods, systems, and apparatuses for producing a variety of nanofibers using very low power output and low voltage DC input using DC to DC voltage converters with dual polarity and a high voltage DC supply.

It is another aspect of the disclosed embodiments to provide methods, systems and apparatuses for producing filtering materials that can be used in personal protective equipment such as face masks at large scale.

The aforementioned aspects and other objectives and advantages can now be achieved as described herein. Various additional embodiments and descriptions are provided herein. For example, in an embodiment, an electrospinning system comprises a dual polarity high voltage power supply, a first wire for wire electrospinning held at positive potential by the power supply, a second wire held at negative potential by the power supply, and a spooling system for drawing an uncoated substrate between the first wire and the second wire. In an embodiment, the power supply comprises a dual polarity power supply. In an embodiment, of the electrospinning system the spooling system further comprises an uncoated substrate spool configured to hold a spool of the substrate. In an embodiment, the substrate comprises non-woven melt-blow polypropylene. In certain embodiments, the spooling system further comprises at least two free spinning spools configured to draw the substrate between the first wire and the second wire. The spooling system can further comprise a motor and a driving spool connected to the motor wherein the driving spool pulls the substrate into a roll. In an embodiment, the electrospinning system further comprises a slider and a solution chamber in fluidic connection with the slider, wherein the slider slides along the first wire delivering a solution to the wire. The solution can comprise a co-polymer grade Polyvinylidene fluoride or polyvinylidene difluoride; N,N-dimethylformamide; and Acetone, mixed with a Trifluoroacetic acid.

In another embodiment a method comprises holding a first wire at positive potential, holding a second wire held at negative potential, and drawing an uncoated substrate between the first wire and the second wire, wherein a solution on the first wire is coated onto the substrate. In an embodiment, the first wire is held at positive potential with a dual polarity power supply and the second wire is held at negative potential with the dual polarity power supply. In an embodiment, the method further comprises spooling the uncoated substrate on an uncoated substrate spool. the substrate can comprise non-woven melt-blow polypropylene. In an embodiment the method comprises drawing the substrate between at least two free spinning spools configured such that the substrate passes between the first wire and the second wire. In an embodiment the method comprises pulling the substrate into a roll with a driving spool connected to a motor. In an embodiment the method comprises sliding a slider connected to a solution chamber along the first wire and delivering solution from the solution chamber along the first wire. In an embodiment, the solution comprises a co-polymer grade Polyvinylidene fluoride or polyvinylidene difluoride; N,N-dimethylformamide; and Acetone, mixed with a Trifluoroacetic acid.

In another embodiment, a method for fabricating a material comprises coating a substrate with a nanofiber material, and sandwiching the coated substrate between an outer layer and an inner layer. Coating a substrate with a nanofiber material further comprises holding a first wire at positive potential, holding a second wire held at negative potential, and drawing the substrate between the first wire and the second wire, wherein a solution on the first wire is coated onto the substrate. In an embodiment, the outer layer comprises melt-blown non-woven spunbound polypropylene filter cloth with an average fiber diameter of up to 10 microns and open porosity of up to 10 microns. In an embodiment, the inner layer comprises non-woven spunbound polypropylene filter cloth with a diameter between 20 microns and 50 microns.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 depicts a block diagram of an electrospinning system, in accordance with the disclosed embodiments;

FIG. 2A depicts a photograph of a nanofiber mat that can be produced according to the methods and systems disclosed herein;

FIG. 2B depicts a nanofiber material, in accordance with the disclosed embodiments;

FIG. 3A depicts a dual power supply, in accordance with the disclosed embodiments;

FIG. 3B depicts a dual power supply, in accordance with the disclosed embodiments;

FIG. 4 depicts steps in a method for creating an electrospun fiber mat, in accordance with the disclosed embodiments;

FIG. 5 depicts a layered material, in accordance with the disclosed embodiments;

FIG. 6A depicts a face mask incorporating a layered material, in accordance with the disclosed embodiments;

FIG. 6B depicts an alternative face mask incorporating a layered material, in accordance with the disclosed embodiments;

FIG. 6C depicts a face mask structure incorporating a layered material, in accordance with the disclosed embodiments;

FIG. 7A depicts an alternative face mask incorporating a layered material, in accordance with the disclosed embodiments;

FIG. 7B depicts an alternative face mask incorporating a layered material, in accordance with the disclosed embodiments;

FIG. 7C depicts an alternative face mask incorporating a layered material, in accordance with the disclosed embodiments;

FIG. 8A depicts a system for coating a substrate, in accordance with the disclosed embodiments;

FIG. 8B depicts a slider mechanism associated with an electrospinning setup, in accordance with the disclosed embodiments;

FIG. 8C depicts a spooling system associated with a system for coating a substrate, in accordance with the disclosed embodiments;

FIG. 9A depicts a front view of a spooling system, in accordance with the disclosed embodiments;

FIG. 9B depicts a side view of a spooling system, in accordance with the disclosed embodiments;

FIG. 9C depicts a top view of a spooling system, in accordance with the disclosed embodiments; and

FIG. 10 depicts a flow chart of steps associated with a method for creating a filtering material, in accordance with the disclosed embodiments.

### DETAILED DESCRIPTION

The particular values and configurations discussed in the following non-limiting examples can be varied, and are cited merely to illustrate one or more embodiments and are not intended to limit the scope thereof.

Example embodiments will now be described more fully hereinafter, with reference to the accompanying drawings, in which illustrative embodiments are shown. The embodiments disclosed herein can be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. Dimensions or ranges illustrated in the figures are exemplary, and other dimensions can be used in other embodiments. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

The embodiments disclosed herein are drawn to methods, systems, and apparatuses for electrospinning or coating. Electrospinning can be understood as a process for producing polymeric fiber. In some embodiments, this can include producing nanofiber mats. Generally, electrospinning operates by applying a high voltage to a specially prepared liquid that is formed into droplets at a dispensing point, such as a needle. The body of the drop is charged by the high voltage. Electrostatic repulsion creates a stream of liquid, that is ejected from the dispensing point, commonly referred to as a “Taylor Cone.” The liquid stream dries as it travels toward a grounded collector. The drying liquid stream can be elongated by a whipping process. The dried and whipped fiber collects on the collector in a mat of generally, thin and uniform fiber, or coats a substrate.

The embodiments disclosed herein describe compact nanofiber production systems and coating systems with the ability to produce a variety of ceramic nanofibers or polymeric materials. The nanofiber production systems can have very low power output and low voltage DC input. This is made possible by using a DC to DC voltage converter with a dual polarity high voltage DC supply, as disclosed herein.

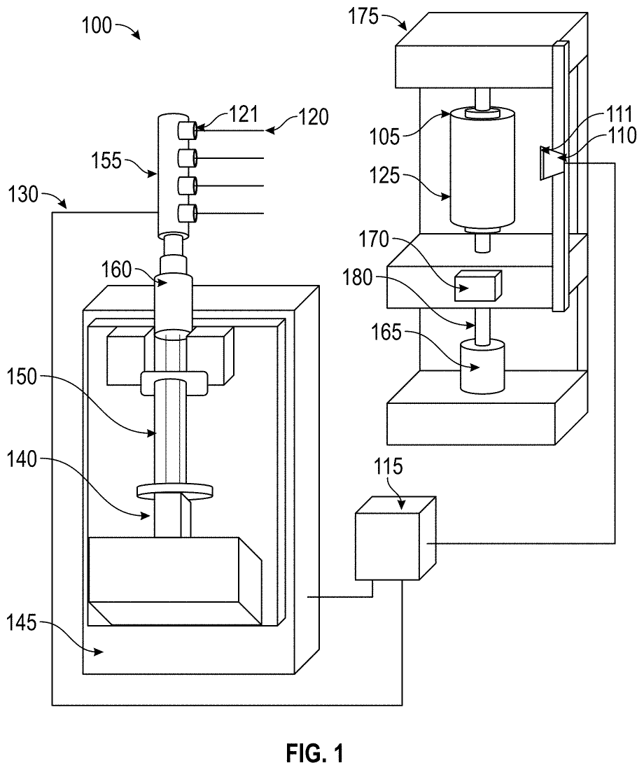

FIG. 1 illustrates an exemplary embodiment of an electrospinning system 100 employing a dual polarity source 115, for mass production of a nanofiber mat comprising Zirconia, other such ceramic material (e.g. alumina, Tungsten oxide, Titania, etc.), or nanofiber filter cloth, polymer filter cloth, etc., using one or more dispensing needles in a needle array 120.

The system 100 takes advantage of Corona discharge. Corona discharge creates oppositely charged ions to neutralize charge accumulation on the nanofiber mat thereby enabling the creation of a thick nanofiber mat.

In FIG. 1, a rotating collector 105 (e.g. a drum collector) is held at ground potential via ground 170. A Corona discharge assembly 175 can include a plate 110, having a knife edge 111, connected to a DC voltage source 115 that drives the Corona discharge. Nanofibers are ejected from one or more needles in the needle array 120 as shown. It should be appreciated that in FIG. 1, four needles in needle array 120 are shown but in other embodiments the number of needles can vary according to the scale of the system 100 and size of the desired nanofiber mat 125. For example, the number of needles can be adjusted to accommodate production of a larger/smaller or wider/narrower nanofiber mat. Arrangement of the needles in needle array 120 need not be linear. For example, in other embodiments, the needles in needle array 120 can be staggered or otherwise configured in any number of ways along needle manifold 155.

The system 100 can include a dual polarity power supply 115 connected to a solution dispensing assembly 130. The solution dispensing system 130 includes an actuator 140 that is connected to a syringe pump 145. The actuator 140 is fixed to a plunger 150 that is connected to a needle manifold 155. The syringe pump 145 controls the actuator 140, which pushes liquid 160 to the needle array 120 through the needle manifold 155.

The liquid 160 can comprise positively charged ions of a desired material. In certain embodiments the liquid 160 can include possible precursor solutions including Alumina→Aluminum 2,4-pentadionate+Aceton, Zirconia→Zirconium Carbonate+Acetic Acid, WO₃→Ammonium meta-tungstate+D.I. Water, and TiO₂→Titanium Isopropoxide. These solutions can be added with polymeric solution containing approximately 5-8 wt % of polyvinylpyrrolidone in Acetone or Ethanol.

The needle manifold 155 can be configured to include one or more needle ports 121 that connect the one or more needles in the needle array 120 to the needle manifold 155. In certain embodiments, the needle array 120, illustrated in FIG. 1, can comprise blunt needles with an internal diameter on the order of a few hundred microns.

In the embodiment illustrated in FIG. 1, the needle manifold 155 can comprise a manifold and has been designed to hold the needle array 120 at high +Ve potential. The needle manifold 155 can be 3-D printed, or can be manufactured according to other known techniques. The knife edge 111 on plate 110 is similarly maintained at a high −Ve potential to generate −Ve ions. In combination, this assembly increases the production rate of the electrospinning system 100.

A certain distance, for example, 1-5 centimeters can be maintained between the needles 120 to avoid squeezing the nanofiber cone volume that emanates from the needles 120 during use. Nanofiber constituted liquid emerging from each needle in the needle array 120 travels to the ground plate 110 in a spiral action which results in a cone like formation. Since each of the nanofibers emanating from the needle array 120 are of the same charge, they increasingly repel each other according to their relative proximity, thereby squeezing the cone of travel. Eventually this squeezing action can become sufficiently prevalent that it will lead to non-uniform deposition of nanofibers on the drum collector. Thus, in the embodiments disclosed herein, an exemplary distance between needles in the needle array 120 should be maintained to prevent this effect. In certain embodiments this distance can be at least 1 inch. This distance is sufficient to avoid squeezing of the spinning area from individual needles, due to charge repulsion, while allowing for some overlap to produce uniformity in the axial direction of the rotating collector 105.

Appropriate distance and voltage can also be maintained between the rotating collector 105 and the knife edge 111 to prevent the breakdown of air which could result in a spark instead of ionization. Although the rotating collector 105 and knife edge 111 are illustrated in FIG. 1, in other embodiments, a set of micro-tipped (e.g., approximately 10 micron tip diameter) tungsten/metallic needles can also be used to produce corona discharge, as further detailed in the embodiments presented herein.

Thus, in the embodiment illustrated in FIG. 1, the power supply 115 provides a positive DC voltage to the needle array 120 and a negative DC voltage to the knife edge 111 positioned near the rotating drum collector 105, which is kept at ground potential. The potential difference between the needle array 120 and the drum/knife edge 111 provides the attractive force that results in the thin liquid jet depositing material 125 on the rotating drum 105. The drum 105 is rotated with a motor 165 connected to a drive shaft 180, so that a mat of surrounding fiber 125 is deposited on the drum 105. It should be appreciated that this summarizes the general functionality of embodiments disclosed herein. Other arrangements are further detailed herein.

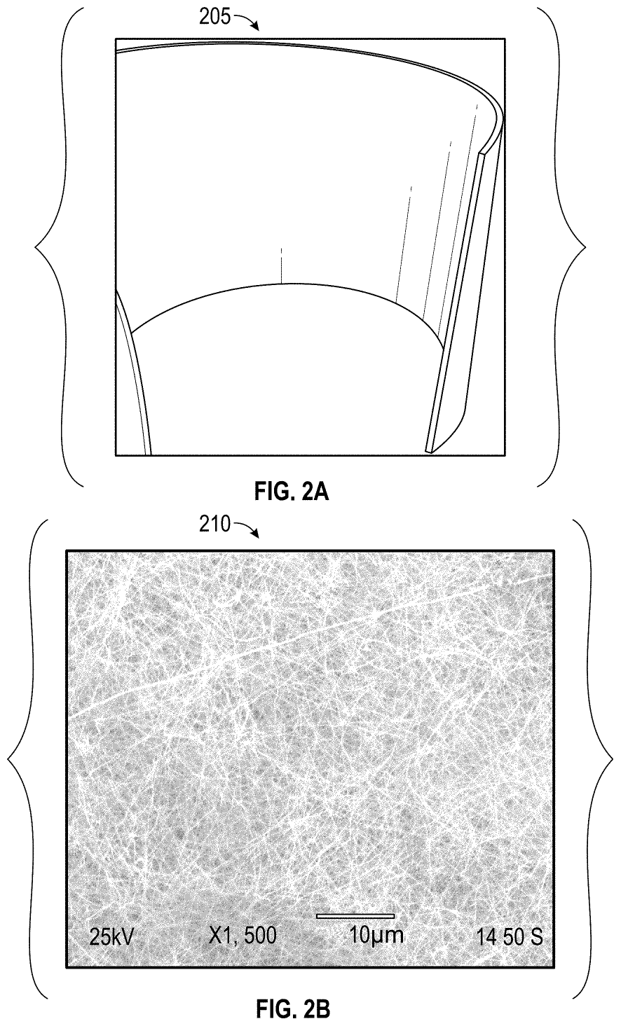

A photograph of a nanofiber sheet 205 being peeled off a cylinder is illustrated in FIG. 2A. The photograph in FIG. 2B illustrates a nanofiber microstructure 210. It should be appreciated that in other embodiments, other materials can be used to produce mats of materials and/or to coat underlying substrates with such materials.

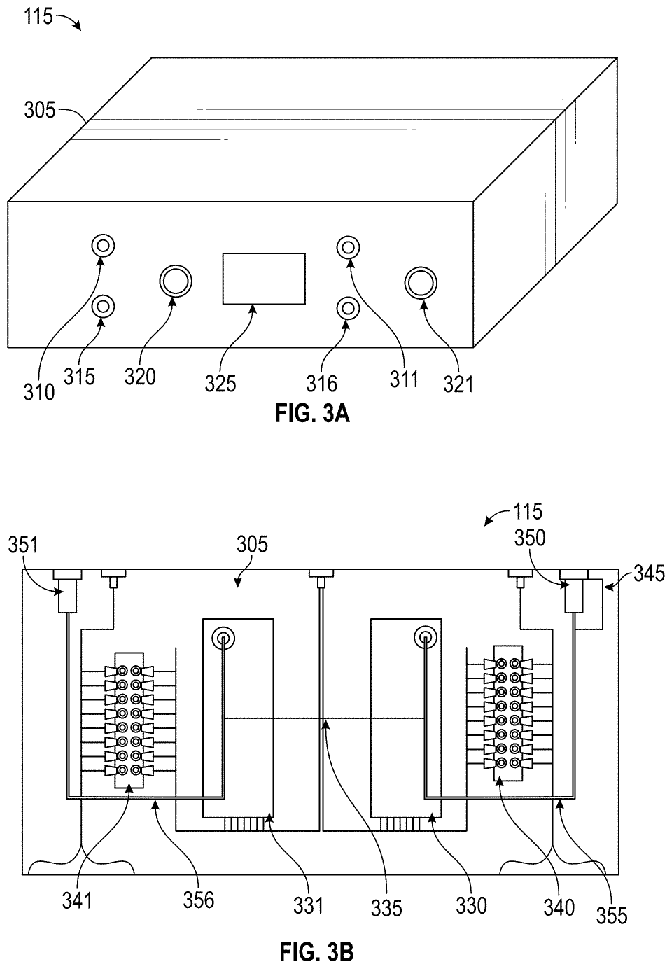

FIGS. 3A and 3B illustrate an exemplary embodiment of the dual power supply 115. Two power units (one +40 kV and one −20 kV) can be assembled inside a housing 305 as illustrated in FIG. 3A. It should be understood that housing 305 can comprise a metal box, or other such housing. Each power unit has an individual potentiometer to vary input voltage, which, in turn, can be used to vary the high voltage output from approximately 0-40 kV DC. A potentiometer 320 can be provided for the first power supply and a second potentiometer 321 can be provided for the other power supply in the housing 305. The housing 305 can further include a display 325. The housing can provide a voltage sensor port 310 and current sensor port 315 associated with one power supply, and a second voltage sensor port 311 and current sensor port 316 associated with the other power supply.

FIG. 3B shows inside the assembled power supply 115. The power supply 115 includes two high voltage converters (one positive high voltage converter 330 and one negative high voltage converter 331) connected with a connector junction 335. The positive high voltage power converter 330 is connected to a high voltage DC output 355. The negative high voltage power converter 331 is connected to a high voltage DC output 356 The positive voltage converter 330 has a junction box 340 for connecting to the potentiometer, voltage and optional voltage/current display. Likewise, the negative voltage converter 331 has a junction box 341 for connecting to the potentiometer, voltage and the optional voltage/current display. The output voltage/current sensing ports can be connected to the digital display unit 325 for easy readability.

As illustrated in FIG. 3B, the voltage supply assemblies are simple and connections can be made easily, without the need for complicated printed circuit boards, although in certain embodiments PCBs can alternatively be used. The grounding wire 345 can be connected to the box 305 for safety purposes. Likewise, spark protection lug 350 and spark protection lug 351 can be provided. It is important to select an appropriate length for the spark protection lugs 350 and 351, and to maintain safe distances between the high voltage cable and exposed wire to the nearby ground/metal surface.

It should be appreciated that the dual polarity power supply assembly 115 illustrated in FIGS. 3A and 3B is useful for producing a nanofiber mat. The embodiments disclosed herein can use the dual polarity high voltage assembly 115 such that one polarity drives the nanofiber production while the opposite polarity is used for the negatively charged ions, which results in the Corona discharge through the specially arranged needle array. Dual polarity also results in an effective potential drop of up to 60 KV DC. Such high potential is necessary for mass producing nanofiber coatings on substrates as described herein.

In the embodiments disclosed herein, a critical aspect is the power supply 115, which can use a low voltage DC input and inexpensive DC to DC voltage converters with a dual polarity high voltage DC supply. A major advantage realized by this arrangement is that the power supply 115 can be, for example, limited to 4 watts of output power while maintaining a 0 to 40 kV DC and 0 to −20 kV DC output in dual polarity mode, simultaneously from a 9V/12V DC battery or a 12 V DC adapter. Thus, the power supply 115 can be characterized as having a nominal input voltage of 12 V DC, a voltage range of approximately 9 V-32 V DC, an output voltage of approximately 0 to +40 kV DC and 0 to −20 kV DC, indefinite output short-circuit protection, and ripple of 0.02.

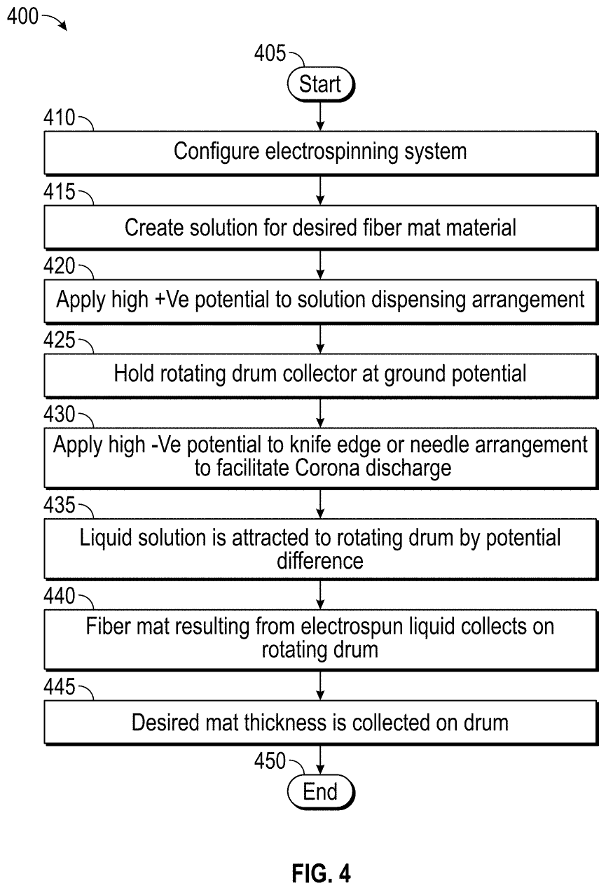

FIG. 4 illustrates a method 400 for producing a nanofiber mat in accordance with the disclosed embodiments. The method starts at step 405.

At step 410, an electrospinning system, in accordance with any of the embodiments disclosed herein, can be configured. The electrospinning system can take advantage of a dual polarity source as disclosed in the various systems detailed herein. A solution can be created for the desired mat fiber material, as illustrated at step 415. Possible precursor solutions include 7-15 wt % of co-polymer grade PVDF (Polyvinylidene fluoride or polyvinylidene difluoride), in 50:50˜20:80 wt % DMF (N,N-dimethylformamide) and Aceton. 1-5 wt % of TFA (Trifluoroacetic acid) can be added to the above solution.

Once the solution is ready, at step 420 a high positive potential can be supplied to the solution dispensing arrangement. As disclosed herein, in some embodiments, the solution dispensing arrangement can be one or more needles or wires. The rotating drum can be held at ground potential as illustrated at 425. In other embodiments, the solution dispensing arrangement can comprise a rotating spindle with associated solid needles or spikes that are dipped into a pool of solution. A high negative potential can be supplied to a knife edge, needle, or wire arrangement to facilitate discharge as shown at 430, resulting in a thicker fiber mat or coat of material on a passing substrate.

The liquid solution is drawn away from the solution dispenser by the potential difference as illustrated at 435. As the liquid passes through the air, it is pulled into a fiber that is collected on the rotating drum, resulting in a fiber mat or coating as shown at step 440. The process continues until the fiber mat is of a desired thickness as shown at step 445, at which point the method ends at 450.

An aspect of the disclosure provided herein is directed to methods and systems to increase the filter efficiency of virus filtering material and masks to close to 100% while keeping the flow resistance for respiration to a minimum (<5 0 Pa @ 85 L.min) by coating a thin layer of 1-D continuous nanofiber on a low filter efficiency substrate filter cloth of melt-blown non-woven polypropylene material.

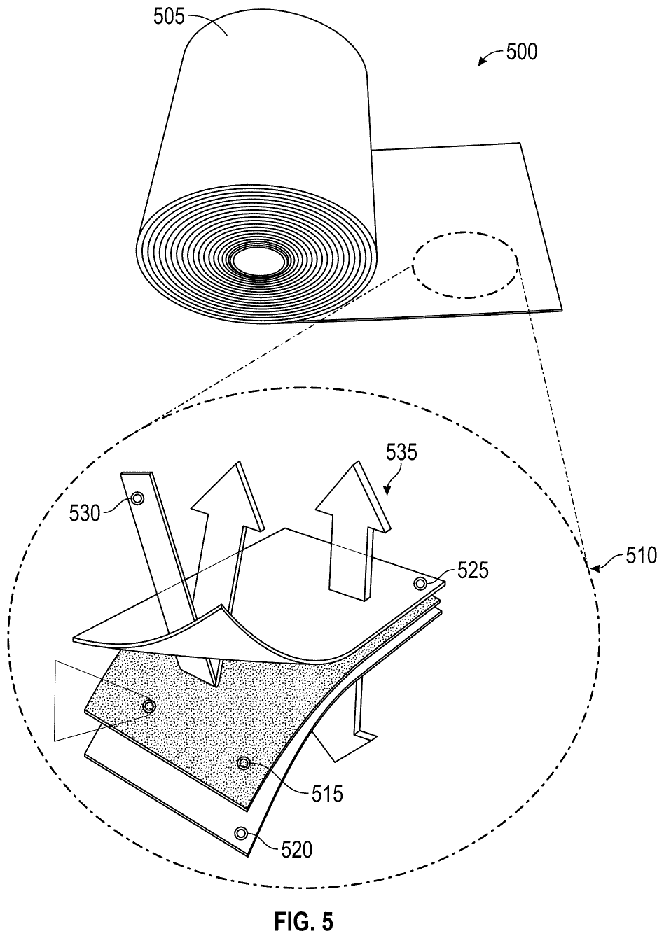

FIG. 5 illustrates one embodiment of a filtering material 500 in accordance with the disclosed embodiments. FIG. 5 illustrates a roll 505 of filtering material 500. Exploded view 510 illustrates Nanofiber coated filter cloth 515, that can be sandwiched between two layers of spun bond polypropylene filter cloth; inner layer 520 and outer layer 525.

The nanofiber layer 515 can have randomly oriented 1-D continuous nanofiber with an average diameter of up to 0.1 micron and pore opening size of between 0.1-0.3 microns and coating thickness of between 5˜10 microns. The thin layer of nanofiber and open pore size of less than half that of many viruses (including the COVID-19 virus) ensures such viruses and other biological or environmental contaminants will be filtered completely as illustrated by arrow 530. Since only a thin membrane of a few microns thick nanofiber layer is used, there is also less pressure drop across this layer. As such, airflow 535 is improved, which can increase breathability.

In certain embodiments, the nanofiber layer 515 can be a thin (up to 0.15 mm thick) 10 gsm melt-blown non-woven polypropylene filter cloth with average fiber diameter of up to approximately 10 microns and open porosity of up to 10 microns. The substrate has an optimum fiber diameter and pore size to act as a support layer for the nanofiber membrane, thereby providing low resistance to airflow (e.g. 10 Pa pressure drop at 85 L/min).

The inner layer 520 can comprise a spun bond non-woven polypropylene filter cloth (e.g. up to approximately 10 gsm, with a diameter between approximately 20 micron fiber diameter and approximately 50 microns). This layer can be in direct contact with a human's skin and act as a support to the nanofiber coated 10 gsm melt-blown layer.

The outer layer 525 can comprise a spun bond non-woven polypropylene filter cloth, (e.g. approximately 20 gsm, with a fiber diameter between approximately 20 microns and 50 microns). This layer also offers far less resistance to air flow due to its large pore size. The layer also gives added mechanical strength to the sandwiched filter roll, which is necessary to sustain pulling force during the face mask manufacturing process and while wearing the face mask. The combined pressure-drop across these layers is less than 100˜130 Pa at an 85 L/min flow rate, which exceeds the performance of currently available N95 face masks.

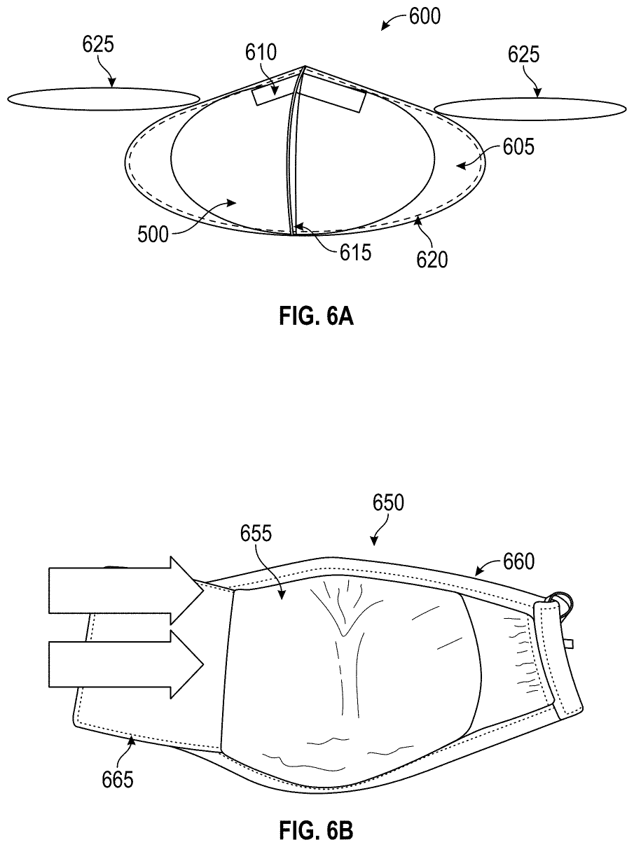

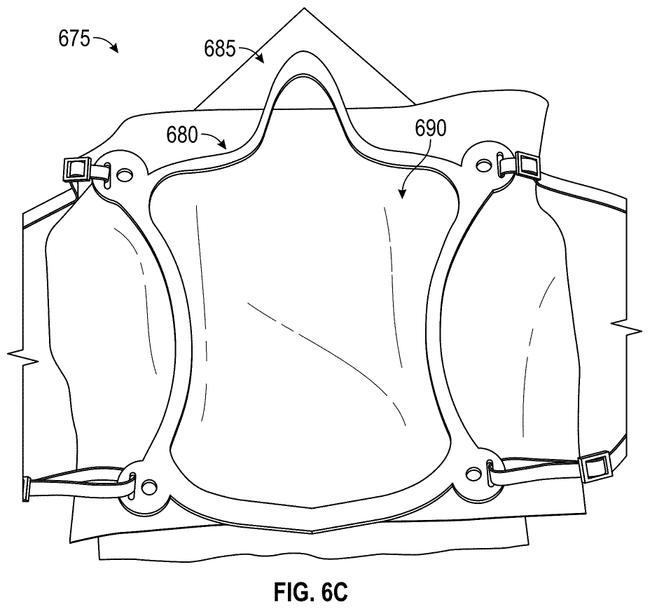

FIG. 6A illustrates a face mask 600 configured from the above disclosed materials in accordance with the disclosed embodiments. The face mask comprises a larger mask body 605. A portion of the mask body 605 around the nose and mouth comprises the nanofiber sandwiched laminated three-layered filter material 500 disclosed herein (for example in FIG. 5).

Other features of the mask 600 are intended to create a seal between the mask 600 and face to ensure contaminated air does not enter the mask 600. These features can include nose tape 610 formed along the top edge of the mask body 605 where the mask contacts the nose bridge. The mask 600 can include vertical stitching 615 along the center of the mask 600. The mask 600 also includes a border contour seal 620 such that when the ear strap(s) 625 are put around the head, there is no gap between the skin and the face mask 600.

FIG. 6B illustrates another embodiment of a mask in accordance with the disclosed embodiments. It should be appreciated that some or all aspects of FIG. 6A can be incorporated in FIG. 6B. In the case of the mask 650 in FIG. 6B, the mask 650 can be formed of a cotton material that can be washed. The cotton structure can include a pocket 655 formed therein generally located around, or proximate to, the area of the mask 650 covering a user's nose and mouth. The pocket 655 can be formed of a large pore cotton material, lace, or other such configuration. Using large pore material will offer less resistance to air flow in front of nostrils. Hence there will be less suction of air around the border of the cotton mask.

A wire 660 such as a 6 gauge wire can be used on the top border of the mask 650, so that the shape of the mask 650 can be contoured to a user's face. An insert 665 can then be inserted into the pocket 655 in the mask.

The insert 665 can comprise a Nanofiber coated 10 gsm melt-blown non-woven polypropylene fabric filter (such as filter material 500). The Nanofiber coated filter pad insert 665 can have a 0.1 micron-0.3 micron average pore size. The nanofiber coating can be between 5-15 microns. Thus, it creates less resistance to air flow as compared to a standard N95 mask, while also providing better filtering efficiency (e.g. up to 99% Bacteria filter). Additionally, the mask 650 of FIG. 6B including the cotton body of the mask in FIG. 6B can be washed while the nanofiber coated insert 665 pad can be replaced (for example after 1-2 weeks).

FIG. 6C illustrates another embodiment of a mask template 675 in accordance with the disclosed embodiments. As illustrated in FIG. 6C, a mask template 675 can be used to properly size the layers of the filtering material, such as filtering material 500. The materials can then be fitted to a frame 680 as illustrated in FIG. 6C. The frame 680 can comprise a foam, plastic, or malleable wire frame, such that the contours of the frame create a nearly airtight seal with the user's face.

For example, in certain embodiments, a mask according to FIG. 6C, can be fabricated by stamping out the illustrated shape 685 from rubber sheet or silicone sheet or injection molded part. Next, two layers of cotton fabric with larger pores can be stitched around the border, with a pocket in between if desired. Then a single piece of nanofiber coated 10 gsm meltblown non-woven polypropylene fabric 690 can be connected to the fabric, or inserted in the pocket.

The embodiment in FIG. 6C is advantageous because the silicone/rubber frame 680 will ensure a complete air seal. The nanofiber coated fabric 690 will ensure 99% filtering efficiency against COVID19 or other viruses, and the pressure drop of <60 Pa is significantly lower than other filtering masks making the design more breathable and comfortable to wear.

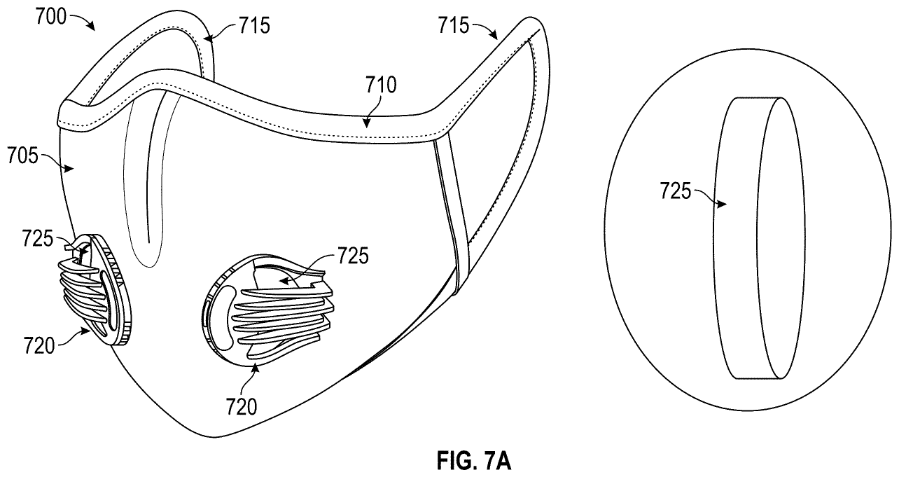

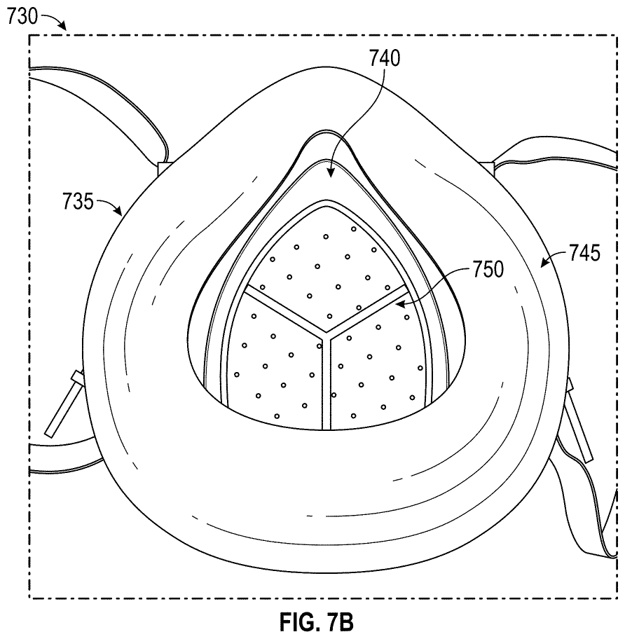

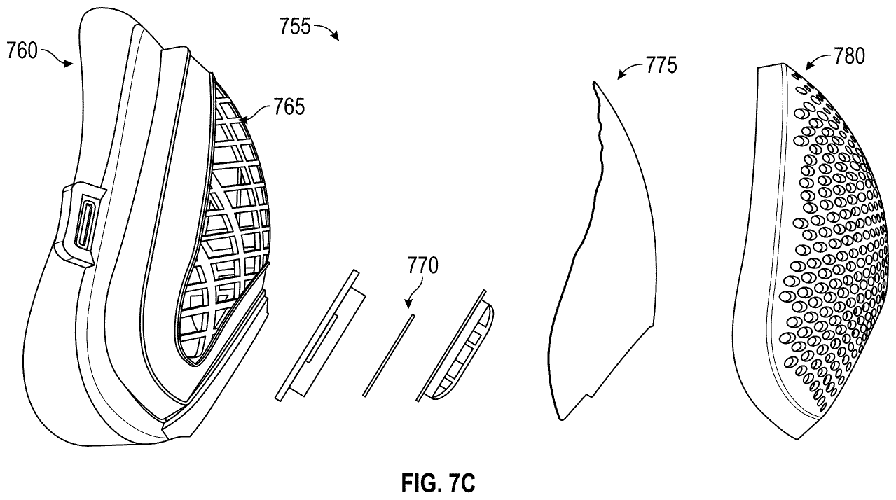

Additional embodiments, of personal protective equipment masks according to the embodiments disclosed herein are provided in FIGS. 7A-7C. FIG. 7A illustrates a vented mask configuration 700. As illustrated in FIG. 7A, the vented mask configuration 700 includes a mask body 705 configured with an outer wire 710 configured to conform to a user's face, and ear loop(s) 715. Vented mask 700 is further configured with vents 720. The vents 720 can be fitted with filters 725.

The filters 725 (illustrated in the exploded view) can be sized to be inserted into the vents 720. The filters 725 can comprise a nanofiber coated 10 gsm melt-blown non-woven polypropylene fabric filter (such as filter material 500). The filter 725 collects unwanted contaminates while allowing airflow at a lower pressure drop than conventional filtering material.

FIG. 7B illustrates another embodiment of a silicone vented mask 730. The silicone vented mask 730 can comprise a mask body 735 which is generally configured with an outward facing surface 740 connected to face flaps 745. The mask body thus forms an inner orifice into which a user can insert their nose and mouth. The face flaps 745 create a nearly perfect airtight seal with the user's face.

The outward facing surface includes a filter pad 750. The filter pad 750 can be sized to fit in an opening in the outward facing surface. The filter pad 750 can comprise a nanofiber coated 10 gsm melt-blown non-woven polypropylene fabric filter (such as filter material 500). The filter collects unwanted contaminates while allowing airflow at a lower pressure drop than conventional filtering material.

FIG. 7C illustrates a separated view of another embodiment of a cage style mask 755. The cage style mask 755 can include a silicone face flap 760 affixed to a mask cage 765. Exhaust valves 770 can be configured on the mask cage 765. Next a filter pad 775 can be configured over the mask cage 765 and exhaust valves 770. The filter pad 775 can be held in place by a detachable cover 780. The detachable cover allows the filter pad 775 to be removed and replaced quickly.

The filter pad 775 can be sized to fit in an opening in the outward facing surface. The filter pad 775 can comprise a nanofiber coated 10 gsm melt-blown non-woven polypropylene fabric filter (such as filter material 500). The filter collects unwanted contaminates while allowing airflow at a lower pressure drop than conventional filtering material.

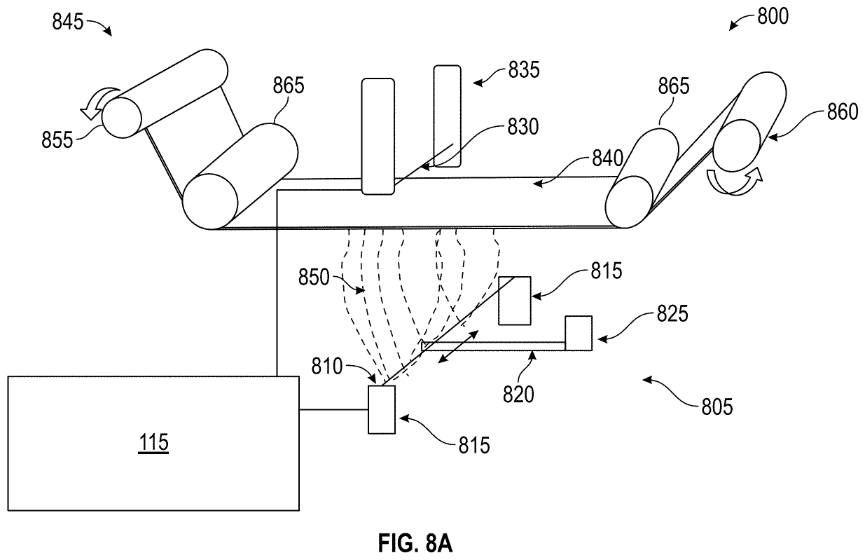

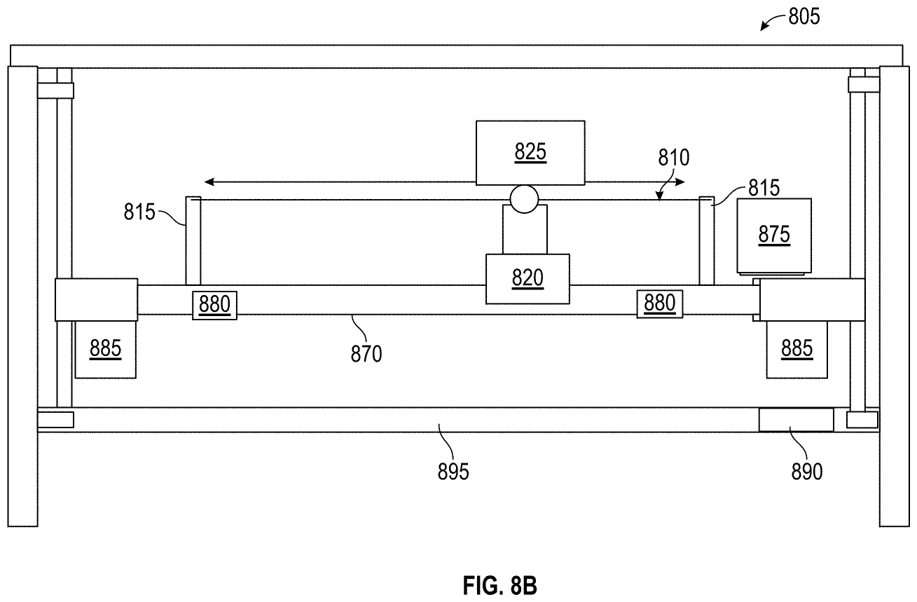

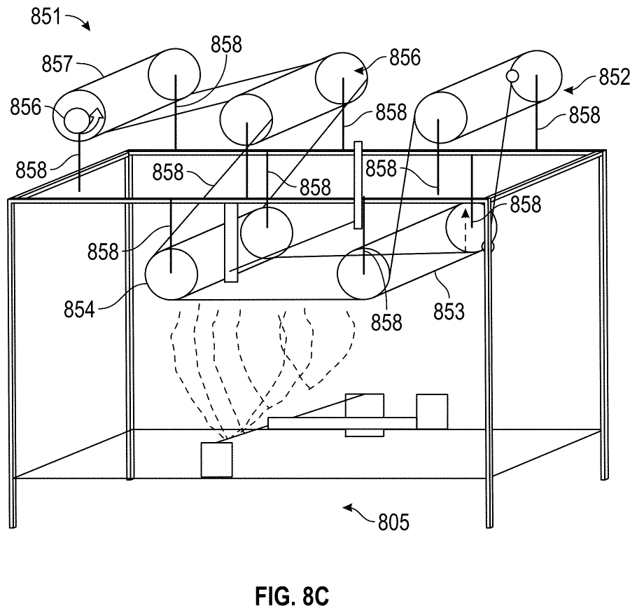

In further embodiments, a system 800 to mass produce nanofiber layers of polypropylene using a low-cost electrospinning set up are disclosed. The system 800 is illustrated in FIG. 8. The system 800 can make use of a low-power output, high voltage DC power supply 115 (as illustrated in FIGS. 3A and 3B), which is extremely safe and can be operated with a basic power source, such as mains power, or a 12V battery.

The power supply 115 can be connected to a free surface wire electrospinning setup 805 as illustrated in FIG. 8 to produce a variety of polymer nanofibers in continuous production mode with diameters ranging from 0.1-0.3 microns.

The free surface wire electrospinning setup 805 comprises a wire 810 extended between two stands 815. The wire 810 is held at a high positive DC voltage by the power supply 115. A slider 820 is configured below the wire 810, with a polymer solution chamber 825 connected to the slider 820. The slider 820 slides along the wire 810 delivering polymer solution (e.g. PVDF in 10 wt % DMAC+Aceton+TFA) from the polymer solution chamber 825.

A spooling system 845 for the non-woven melt blown polypropylene is arranged above the wire 810. The spooling system 845 can include an uncoated substrate spool 860, where spooled non-woven melt-blow polypropylene is held, a series of free spinning spools 865 can be used to direct the polypropylene mat 840.

A second wire 830, held at high negative DC voltage potential, can be configured above the first wire 810, with the polypropylene mat 840 bisecting the path between the first wire 810 and second wire 830. The spooling system 845 runs the polypropylene mat 840 which serves as the substrate for coating. The potential difference between the first wire 810 and second wire 830 creates a nanofiber film 850 from the lower first wire 810 onto the polypropylene mat 840 above. The slider 820 slides to ensure the width of the polypropylene mat 840 is fully coated. In this way the nanofiber 850 is coated onto the polypropylene mat 840. The coated mat is then spooled into a roll 855 for further processing.

FIG. 8B illustrates a more detailed view of the electrospinning setup 805 as disclosed herein. As illustrated in FIG. 8B, the high voltage steel wire 810 is strung between two nylon posts 815. A sliding nylon block 820 can be connected to an aluminum frame 870. The aluminum frame 870 holds the slider 820, which is driven by a motor 875. A limit switch 880 can be provided. The slider 820 slides along the aluminum frame 870 delivering solution to the wire 810.

In certain embodiments, the high voltage wire 810, which can have a diameter of 0.2 mm-2 mm, passes through a 0.6 mm-2.5 mm diameter opening 890 on a plastic tube 895 carrying solution. The slider 820 holding the solution tank 825 and tube assembly, slides back and forth on the high voltage wire 810 at a set speed using a stepper motor control drive unit. The limit switches 880 at each end of the slider serve to reverse the motor direction when the slider hits them, resulting in back and forth motion. The speed of the slider is controlled by a potentiometer and programming associated with a circuit controller such as an Arduino® or other such device.

As illustrated in FIG. 8B, two additional motors 885, can be provided—one at the bottom left and one at the bottom right side of aluminum 2020 frame with a lead screw attached to the frame. The motors 885 adjust the height of slider assembly vertically in order to maintain an appropriate gap between the high voltage wire 810 and the substrate filter material passing over it. The slider motor 875 slides the solution tank 825 across the +Ve high voltage wire 810. Its rotation is reversed each time the slider hits the limit switches 880 located at the end of aluminum frame 870 enabling the back and forth motion.

FIG. 8C illustrates an alternative spooling system 851 in accordance with the disclosed embodiments. It should be appreciated that some or all of the aspects illustrated in FIG. 8C can be used in other embodiments disclosed herein. In such embodiments, a 10 gsm melt blown polypropylene filter roll 852, or other such material roll, can be configured on standoffs 858. Additional standoffs can be connected to idler spool 853 and idler spool 854 which can be situated at a substantially even elevation. Standoffs 858 can further be used to hold an upper spool over which the filter material can travel after being coated. The spooling system 851 can be driven by a motor 856 attached to driving spool 857, where the nanofiber coated filter cloth is wound.

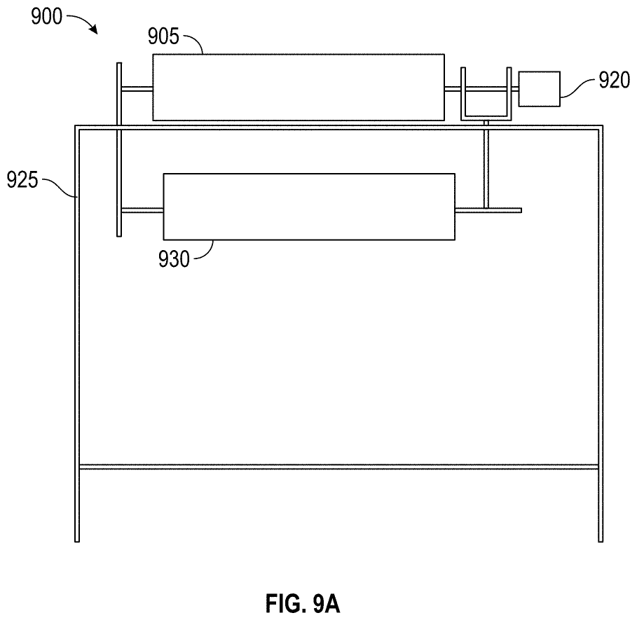

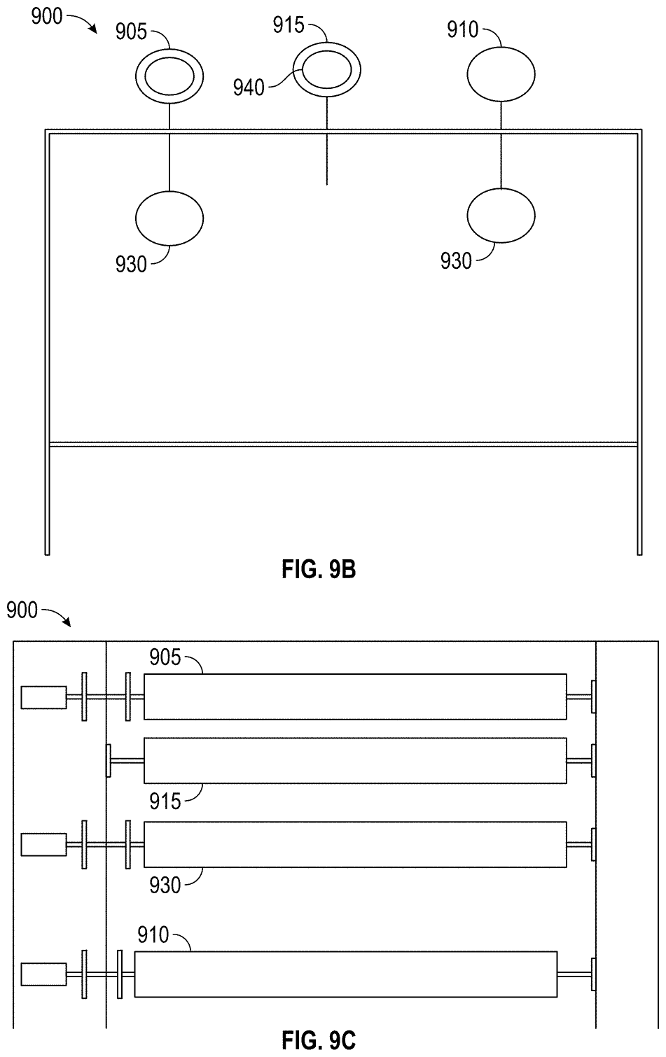

FIGS. 9A, 9B, and 9C illustrate aspects of a tabletop nanofiber coating system 900 in accordance with the disclosed. Aspects of the tabletop nanofiber coating system can be incorporated in other embodiments disclosed herein. FIG. 9A illustrates a front view of the system 900, FIG. 9B illustrates a side view of the system 900, and FIG. 9C illustrates a top view of the system 900. The system 900 can include a set of hanging rollers, and idle rollers, which act as support for moving filter cloth.

As illustrated in FIGS. 9A-9C a driving spool 905, can be operably connected to a motor 920. The motor 920 is mounted to a frame 925. The driving spool 905 serves to wind the coated filter substrate along idler rollers 930, onto a loading spool 910 which severs as the structure onto which the substrate filter, which will be coated, is loaded. An idler roller 915 can be positioned before the driving spool 905. The idler roller 915 can be maintained at a preselected temperature with a heating element 940 for evaporating the solvent residue and to improve adhesion between the nanofiber layer and substrate layer.

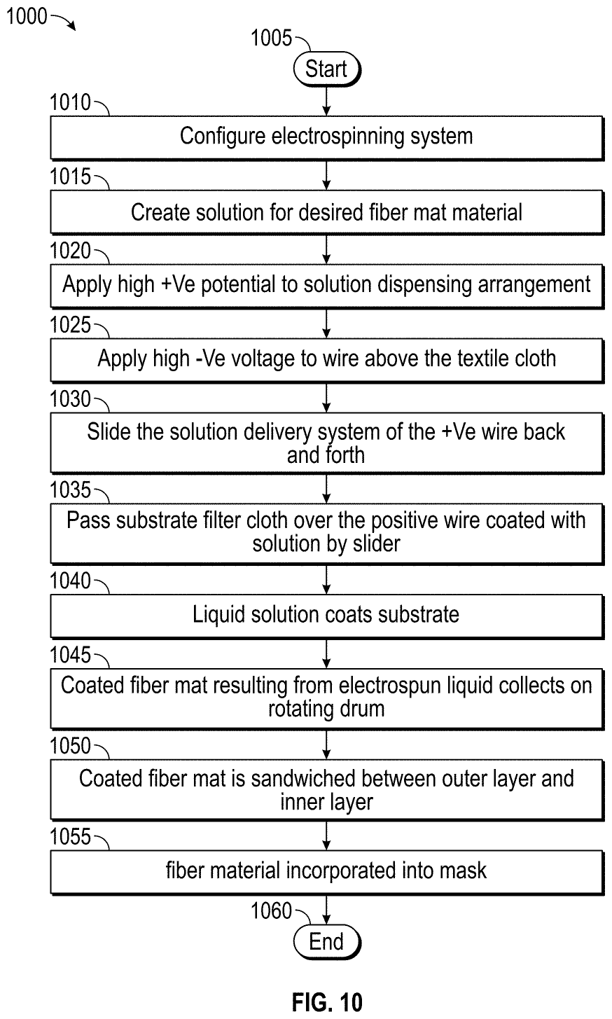

FIG. 10 details steps associate with a method 1000 for producing personal protective equipment such as a face mask, in accordance with the disclosed embodiments. The method begins at 1005.

Initially, as illustrated at 1010, the electrospinning system can be configured. The desired solution for coating the substrate can be selected as illustrated at step 1015. In an exemplary embodiment, the solution can comprise 10 wt % of co-polymer grade PVDF (Polyvinylidene fluoride or polyvinylidene difluoride), in 50:50 wt % DMF (N,N-dimethylformamide) and Aceton. 3 wt % of TFA (Trifluoroacetic acid) can be added to the exemplary solution.

At step 1020, with the system fully set up, a positive potential can be applied to the solution dispensing system and a negative potential can be applied to the wire above the textile cloth, as shown at step 1025, so that there is a potential difference between the wires. The slider associated with the solution delivery system can slide back and forth as illustrated at step 1030.

As such, the dispensing system, such as those illustrated in FIGS. 8 and 9, creates a stream of nanofiber material that can coat the substrate passing above, as illustrated at 1035. In certain embodiments, the stream can comprise a two dimensional plane of material (using the slider). The liquid solution coats the substrate as shown at step 1040. At step 1045, the coated material is then spooled into a roll.

Next, at step 1050, the spooled roll of material can be sandwiched between an inner and outer layer as illustrated, for example, in FIG. 5. The layered material can then be incorporated into any piece of personal protective equipment including, but not limited to, a face mask, to prevent the inhalation of environmental contaminants as illustrated at step 1055. The method ends at 1060.

In operation, the system can coat nanofiber layers of desired specifications on a filter substrate with a production capacity of up to 1000 square meters per day, which is equivalent to 20,000 face masks. This nanofiber coated filter cloth can then be cut into the required size (e.g. face masks), ear straps can be attached, and the masks can be packaged.

In certain embodiments, the disclosed face masks, manufactured as disclosed herein, can filter submicron particles like COVID-19 with close to 99.9% efficiency, offer higher breathability than existing N95 filter masks and, unlike N95, are resistant to oil and water. The disclosed coating machine itself can be built at a low price, almost 20 times cheaper than other commercially-available nanocoaters. It is also much safer to use due to the associated power supply. It can be operated with a 12V battery, at a remote location, where industrial power supplies may not be readily available.

Based on the foregoing, it can be appreciated that a number of embodiments, preferred and alternative, are disclosed herein.

In an embodiment, an electrospinning system comprises a dual polarity high voltage power supply, a first wire for wire electrospinning held at positive potential by the power supply, a second wire held at negative potential by the power supply, and a spooling system for drawing a substrate between the first wire and the second wire. In an embodiment, the power supply comprises a dual polarity power supply.

In an embodiment, of the electrospinning system the spooling system further comprises an uncoated substrate spool configured to hold a spool of the substrate. In an embodiment, the substrate comprises non-woven melt-blow polypropylene.

In certain embodiments, the spooling system further comprises at least two free spinning spools configured to draw the substrate between the first wire and the second wire. The spooling system can further comprise a motor and a driving spool connected to the motor wherein the driving spool pulls the substrate into a roll.

In an embodiment, the electrospinning system further comprises a slider and a solution chamber in fluidic connection with the slider, wherein the slider slides along the first wire delivering a solution to the wire. The solution can comprise a co-polymer grade Polyvinylidene fluoride or polyvinylidene difluoride; N,N-dimethylformamide; and Acetone, mixed with a Trifluoroacetic acid.

In another embodiment a method comprises holding a first wire at positive potential, holding a second wire held at negative potential, and drawing a substrate between the first wire and the second wire, wherein a solution on the first wire is coated onto the substrate. In an embodiment, the first wire is held at positive potential with a dual polarity power supply and the second wire is held at negative potential with the dual polarity power supply.

In an embodiment, the method further comprises spooling the uncoated substrate on an uncoated substrate spool. the substrate can comprise non-woven melt-blow polypropylene.

In an embodiment the method comprises drawing the substrate between at least two free spinning spools configured such that the substrate passes between the first wire and the second wire. In an embodiment the method comprises pulling the substrate into a roll with a driving spool connected to a motor.

In an embodiment the method comprises sliding a slider connected to a solution chamber along the first wire and delivering solution from the solution chamber along the first wire. In an embodiment, the solution comprises a co-polymer grade Polyvinylidene fluoride or polyvinylidene difluoride; N,N-dimethylformamide; and Acetone, mixed with a Trifluoroacetic acid.

In another embodiment, a method for fabricating a material comprises coating a substrate with a nanofiber material, and sandwiching the coated substrate between an outer layer and an inner layer. Coating a substrate with a nanofiber material further comprises holding a first wire at positive potential, holding a second wire held at negative potential, and drawing the substrate between the first wire and the second wire, wherein a solution on the first wire is coated onto the substrate. In an embodiment, the outer layer comprises melt-blown non-woven spunbound polypropylene filter cloth with an average fiber diameter of up to 10 microns and open porosity of up to 10 microns. In an embodiment, the inner layer comprises non-woven spunbound polypropylene filter cloth with a diameter between 20 microns and 50 microns.

It will be appreciated that variations of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. An electrospinning system comprising:
a dual polarity high voltage power supply;
a first wire for wire electrospinning held at positive potential by the power supply;
a second wire held at negative potential by the power supply; and
a spooling system for drawing a substrate between the first wire and the second wire.

2. The electrospinning system of claim 1 wherein the power supply comprises a dual polarity power supply.

3. The electrospinning system of claim 1 wherein the spooling system further comprises:
an uncoated substrate spool configured to hold a spool of the substrate.

4. The electrospinning system of claim 3 wherein the substrate comprises:
non-woven melt-blow polypropylene.

5. The electrospinning system of claim 1 wherein the spooling system further comprises:
at least two free spinning spools configured to draw the substrate between the first wire and the second wire.

6. The electrospinning system of claim 1 wherein the spooling system further comprises:
a motor; and
a driving spool connected to the motor wherein the driving spool pulls the substrate into a roll.

7. The electrospinning system of claim 1 further comprising:
a slider; and
a solution chamber in fluidic connection with the slider, wherein the slider slides along the first wire delivering a solution to the wire.

8. The electrospinning system of claim 7 wherein the solution comprises: a co-polymer grade Polyvinylidene fluoride or polyvinylidene difluoride; N,N-dimethylformamide; and Acetone, mixed with a Trifluoroacetic acid.

9. A method comprising:
holding a first wire at positive potential;
holding a second wire held at negative potential; and
drawing an uncoated substrate between the first wire and the second wire, wherein a solution on the first wire is coated onto the substrate.

10. The method of claim 9 wherein:
the first wire is held at positive potential with a dual polarity power supply; and
the second wire is held at negative potential with the dual polarity power supply.

11. The method of claim 9 further comprising:
spooling the uncoated substrate on an uncoated substrate spool.

12. The method of claim 11 wherein the substrate comprises:
non-woven melt-blow polypropylene.

13. The method of claim 9 further comprising:
drawing the substrate between at least two free spinning spools configured such that the substrate passes between the first wire and the second wire.

14. The method of claim 9 further comprising:
pulling the substrate into a roll with a driving spool connected to a motor.

15. The method of claim 9 further comprising:
sliding a slider connected to a solution chamber along the first wire; and
delivering solution from the solution chamber along the first wire.

16. The method of claim 15 wherein the solution comprises a co-polymer grade Polyvinylidene fluoride or polyvinylidene difluoride; N,N-dimethylformamide; and Acetone, mixed with a Trifluoroacetic acid.

17. A method for fabricating a material comprising:
coating a substrate with a nanofiber material;
sandwiching the coated substrate between an outer layer and an inner layer.

18. The method of claim 17 wherein coating a substrate with a nanofiber material further comprises:
holding a first wire at positive potential;
holding a second wire held at negative potential; and
drawing the substrate between the first wire and the second wire, wherein a solution on the first wire is coated onto the substrate.

19. The method of claim 17 wherein the outer layer comprises:
melt-blown non-woven spunbound polypropylene filter cloth with an average fiber diameter of up to 10 microns and open porosity of up to 10 microns.

20. The method of claim 17 wherein the inner layer comprises:
non-woven spunbound polypropylene filter cloth with a diameter between 20 microns and 50 microns.
